(19) United States
(12) Patent Application Publication
(10) Pub. No.: US 2012/0088021 A1
(43) Pub. Date: Apr. 12, 2012

(54) FUNNEL HANDLE FOR POT LID

(75) Inventor: Christian Baumgarten, Neunkirchen (DE)

(73) Assignee: LENOX CORPORATION, Bristol, PA (US)

(21) Appl. No.: 13/233,139

(22) Filed: Sep. 15, 2011

Related U.S. Application Data
(60) Provisional application No. 61/383,531, filed on Sep. 16, 2010.

(51) Int. Cl. B65B 1/04; A23L 1/01; A23L 1/015; B65D 51/00

(52) U.S. Cl. 426/493; 220/212; 141/1; 426/519; 426/495

(57) ABSTRACT

A liquid feeding device for roasting or stewing pots is described which permits a supply of liquid, to be continuously added to the interior of the pot to compensate for liquids and flavors lost by evaporation, and to add additional flavors to the cooking container. The liquid feeding device is in the form of a fluid reservoir mounted on the cover of the pot, the reservoir having at least one hole through which the liquid stored in the reservoir may slowly escape into the below pot. The rate of flow of liquid from the reservoir to the cooking container may also be regulated by providing structure which permits adjustment of the rate of flow of air into the interior of the reservoir.

### CROSS REFERENCE TO RELATED APPLICATIONS

This application claims priority from, and the benefit of U.S. provisional patent application Ser. No. 61/383,531, filed Sep. 16, 2010, entitled Funnel Handle for Pot Lid, which is pending.

### FIELD OF THE INVENTION

The present invention generally relates to a pot lid having a fluid reservoir and, more particularly, to a fluid reservoir connected to a pot lid in fluid communication with a cooking container and thereby allowing liquid and associated solid-state particles to flow from the fluid reservoir to the cooking container.

### BACKGROUND OF THE INVENTION

The present invention generally relates to cooking containers and the like, and more specifically to a liquid feeding device for a cooking container in the form of a roasting or stewing pot.

Generally, in preparing a roast or cooking meat in roasting or stewing pots, a liquid, and specifically wine or other liquids containing solid-state particles, must be periodically added to compensate for the evaporation of natural liquids of the food being cooked and to add a desired flavor to the cooking process. Liquid must also be added to the food being cooked to assure that roasting sauce or gravy is formed since a sufficient amount of the sauce may be prevented from being formed due to the above described evaporation of liquids.

As is well known in the culinary arts, the addition of liquid for the above purposes requires that the cover of the cooking container be lifted from time to time during the cooking process and the required volume of liquid be added. This step is inconvenient and time consuming, particularly when the cooking time is extended. The inconvenience is particularly acute where the cooking container is placed within a closed broiler since the addition of water in these cases includes opening the broiler, pulling the hot pot out of the broiler and removing the equally hot cover of the pot prior to adding the necessary liquid. These procedures can also be dangerous to the user if the frequent addition of liquid and added flavoring is desired.

The addition of water and other liquids periodically as described above presents a further problem in that the opening of the broiler and pot results in a corresponding drop in temperature within the broiler and within the pot. This extends the cooking time, represents a loss of energy, and may disrupt a preset cooking time set that fails to take into account this loss of heat. Furthermore, each opening of the pot releases vapors and drippings which in time stain both the broiler and surroundings. These are a few of the potential pitfalls associated with taking the lid of a pot off that users of such pots have dealt with for centuries.

An example of a pot lid that attempts to solve this problem is shown in U.S. Pat. No. 4,075,939, issued to Horn et al. (“the '939 patent”). The '939 patent discloses a pot lid having a water reservoir attached to an upper portion of the pot lid. The water reservoir has a porous, liquid permeable bottom wall through which the water stored in the reservoir may slowly be filtered and exit into the food container. A disadvantage of the '939 patent is that the liquid is filtered as it passes through the porous, liquid permeable membrane of the bottom wall of the reservoir. The reservoir does not allow the food to reach a desired flavoring because the solid particles suspended in the liquid are not allowed to exit the reservoir. Therefore, the '939 patent solves a problem with respect to water passing through the porous membrane, as the porous membrane filters out everything from the liquid and only allows the water liquid to pass through. However, the primary problem still remains because there are several other liquids with suspended solid-state particles that need to be released into the food container. This problem has not been dealt with by the '939 patent or any other patent or publication. The present invention addresses this and other problems well known in the art.

The present invention eliminates the above described disadvantages and simplifies and automates the liquid feeding process. As a consequence, there has been a long felt need for a pot lid that holds and allows liquids along with associated solid-state particles to gradually flow into a food container.

### SUMMARY OF THE INVENTION

The present invention provides a pot lid having a fluid reservoir and, more particularly, to a fluid reservoir connected to a pot lid being in fluid communication with a cooking container and thereby allowing liquid and associated solid-state particles to flow from the fluid reservoir to the cooking container.

An embodiment of the present invention includes a fluid reservoir, a disbursement washer, and a disbursement member. In this embodiment, liquid and associated solid-state liquids flow from the fluid reservoir to the disbursement member and the disbursement.

In an alternative embodiment includes a lid body, a fluid reservoir, a disbursement member, and a communication chamber. In this embodiment the fluid reservoir abuts with an upper surface of the lid body, wherein a hole of the fluid reservoir communicates with an opening in the lid body. On the bottom surface of the lid body includes the disbursement washer in connection with a disbursement member. The disbursement washer and the disbursement member also have openings that communicate with the opening through the lid body. This creates a communication channel extending from the fluid reservoir through to the disbursement member.

In another embodiment the present invention includes a method for feeding a liquid with suspended solid-state particles into a container. The method includes the use of the lid pot system of the present invention. After placing the lid pot system on an open container, the user should pour liquid with suspended solid-state particles into the fluid reservoir. The liquid then gradually flows through the fluid reservoir into the communication chamber. The communication chamber releases the liquid with suspended solid-state particles through the disbursement member. In one embodiment, the liquid then proceeds to be released into the container directly beneath the communication chamber. In yet another embodiment, the fluid flows on a surface portion of the disbursement member and gets transferred to the disbursement washer. When the liquid is transferred to the disbursement washer it is released to a wider surface area of the container, thereby spreading the liquid with suspended solid-state particles to a larger portion of food in the container.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is an exploded view of a pot lid having a fluid reservoir that fluidly communicates an external environment with contents enclosed by the pot lid of the present invention;

FIG. 2A is a perspective view of a disbursement member of the present invention;

FIG. 2B is a plan view of a disbursement member of the present invention;

FIG. 2C is a plan view of a disbursement member of the present invention;

FIG. 2D is a side view of a disbursement member of the present invention;

FIG. 3A is a perspective view of a disbursement washer of the present invention;

FIG. 3B is a plan view of a disbursement washer of the present invention;

FIG. 3C is a cross-sectional view of a disbursement washer of the present invention;

FIGS. 4A-4F are cross-sectional views of various exemplary connections between disbursement washer and disbursement member;

FIG. 5A is a perspective view of a lid body of the present invention;

FIG. 5B is a side view of a lid body of the present invention;

FIG. 6A is a perspective view of an outer ring of the present invention;

FIG. 6B is a side view of an outer ring of the present invention;

FIG. 7A is a perspective view of a fluid reservoir having a communication chamber extending therethrough of the present invention;

FIG. 7B is a side view of a fluid reservoir having a communication chamber extending therethrough of the present invention;

FIG. 7C is a plan view of a fluid reservoir having a communication chamber extending therethrough of the present invention;

FIG. 7D is a plan view of a communication chamber of the present invention;

FIG. 8A is a perspective view of a coupling device of the present invention;

FIG. 8B is a top view of a coupling device of the present invention;

FIG. 8C is a bottom view of a coupling device of the present invention;

FIG. 9A is a perspective view of a pot lid having a reservoir that fluidly communicates an external environment with contents enclosed by the pot lid of the present invention.

FIG. 9B is a side view of a pot lid having a reservoir that fluidly communicates an external environment with contents enclosed by the pot lid of the present invention.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. When only a single machine is illustrated, the term “machine” shall also be taken to include any collection of machines that individually or jointly execute a set (or multiple sets) of instructions to perform any one or more of the methodologies discussed herein. The term “operatively connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

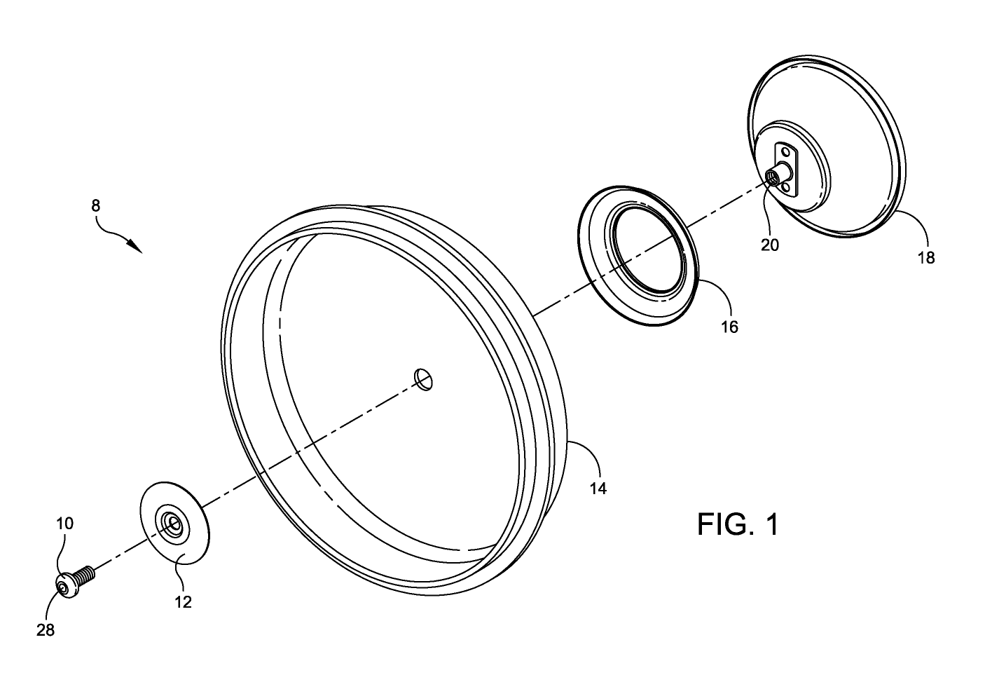

Referring to FIG. 1, FIG. 1 is an exploded view of pot lid system 8 having fluid reservoir 18 that fluidly communicates an external environment with contents enclosed by pot lid system 8 of the present invention. FIG. 1 includes a disbursement member 10, a disbursement washer 12, a lid 14, an outer ring 16, and a fluid reservoir 18 having attached thereto coupling device 20. Pot lid system 8 has a communication channel 28 that extends from fluid reservoir 18 through each component of the system to disbursement member 18 and exits pot lid system 8 through disbursement member 18 and/or through disbursement washer 12.

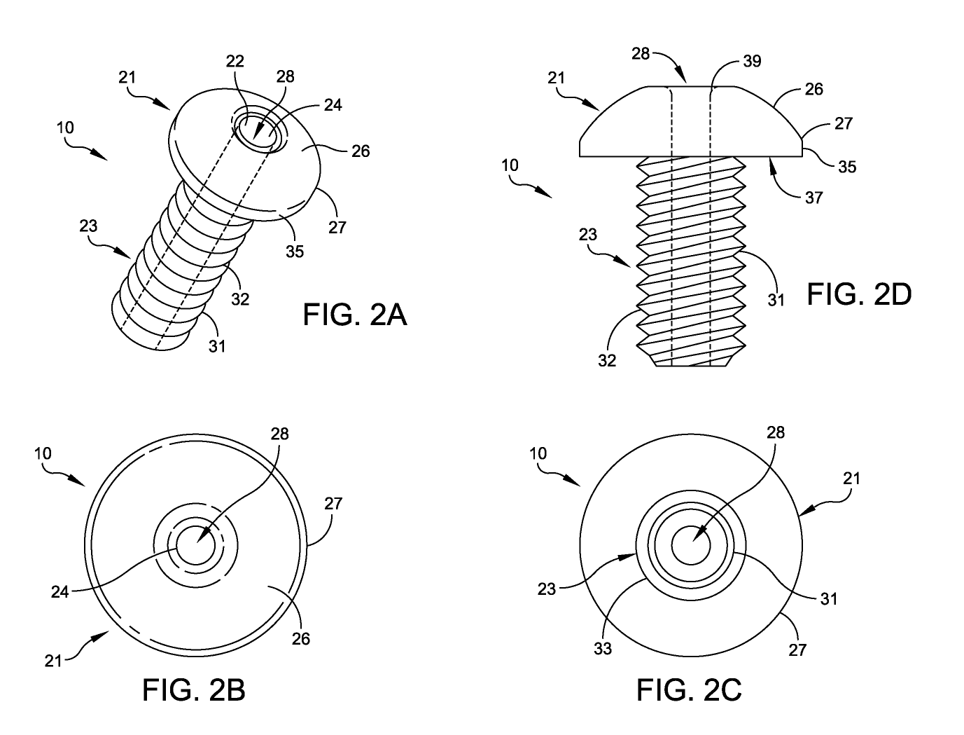

Referring to FIGS. 2A-2D, a disbursement member 10 is shown. Disbursement member 10 has body 21 and hollow member 23 that projects from a center portion of body 21. Body 21 has an inner diameter 24 and outer diameter 27. Inner diameter 24 preferably defines the sidewall portion 22 of communication channel 28. Accordingly, disbursement member 10 has inner sidewall 22 and outer sidewall 31, wherein inner sidewall 22 extends through the length of body portion 21 and hollow member 23. Outer sidewall 31 is preferably a male threaded member with threads 32 so as to be able to secure to a correspondingly female threaded mechanism. Inner sidewall 22 may be a smooth cylindrical surface, preferably in the shape of a cylindrical body, but inner sidewall 22 may also be configured to have a groove extending therethrough, the groove may be straight downwardly extending or may be in the form of a threaded groove gradually extending in a circular manner through inner sidewall 22 (groove not shown in Figs.). Inner sidewall has a diameter at least as large as 1 millimeter, and is preferably about 5 millimeters. Body portion 21 of disbursement member 10 has an upper surface 26 and bottom surface 37. Upper surface 26 is preferably rounded and bottom surface 37 is preferably flat.

There are several embodiments of body portion 21 that may be implemented in order to provide for proper disbursement of the liquid travelling through communication channel 28. For instance, upper surface 26 may be in many different forms. Upper surface 26 may be in the form of a semi circular structure, wherein communication channel 28 extends through a center portion of the semi circle of upper surface 26. In another embodiment, as shown in FIG. 2A, upper portion 26 may be curved inward toward hollow member 23, thereby creating a rounded edge on body portion 21 and another surface 39 extending downwardly. When body portion 21 has an upper surface 26 with a rounded portion extending inward toward hollow member 23, this creates a surface area wherein liquid travelling through communication channel 28 will be more widely disbursed than if upper surface 26 is in the form of a semi circle wherein edge 24 does not extend toward hollow member 23. Body portion 21 may also include an additional sidewall 35 that acts as an extension of body portion 21. Upper surface 26 of disbursement member 10, and even more particularly, inwardly facing surface 39 may be at any desired angle with respect to a crest point of upper surface 26. In general, the larger the angle between inner diameter 24 and the crest of the peak of upper surface 26, the higher the likelihood of a greater surface area liquid disbursement (i.e., the liquid will be disbursed to a larger area when it falls). Whereas, if inner diameter 24 is on the same plane as the crest of upper surface 24 and inwardly facing surface 39 is non-existent, the liquid disbursement likely will mimic the diameter of inner diameter 24 (i.e., the liquid likely will be disbursed to a smaller surface area when it falls). As shown in FIG. 2D, inwardly facing surface 39 may optionally extend at approximately a 45 degree angle from inner diameter 24 to the crest of circular upper surface 26. It should be appreciated that any angle of inwardly facing surface 39 can be implemented in accordance with the present invention.

Hollow member 23 of disbursement member 10 projects away from a center portion of body portion 21. Communication channel 28 also extends through hollow member 23. Hollow member 23 has an outer surface 31, wherein outer surface 31 preferably is threaded with male threads 31 to be sized and configured to be secured with a corresponding female threaded mechanism. Hollow member 23 can be as long or as short as necessary. Communication channel 28 can have a diameter that is as wide or as narrow as necessary. Of course, the larger the diameter of inner surface 22 of hollow member 23, the larger the rate of liquid disbursement that may exit fluid reservoir 18 at any given time.

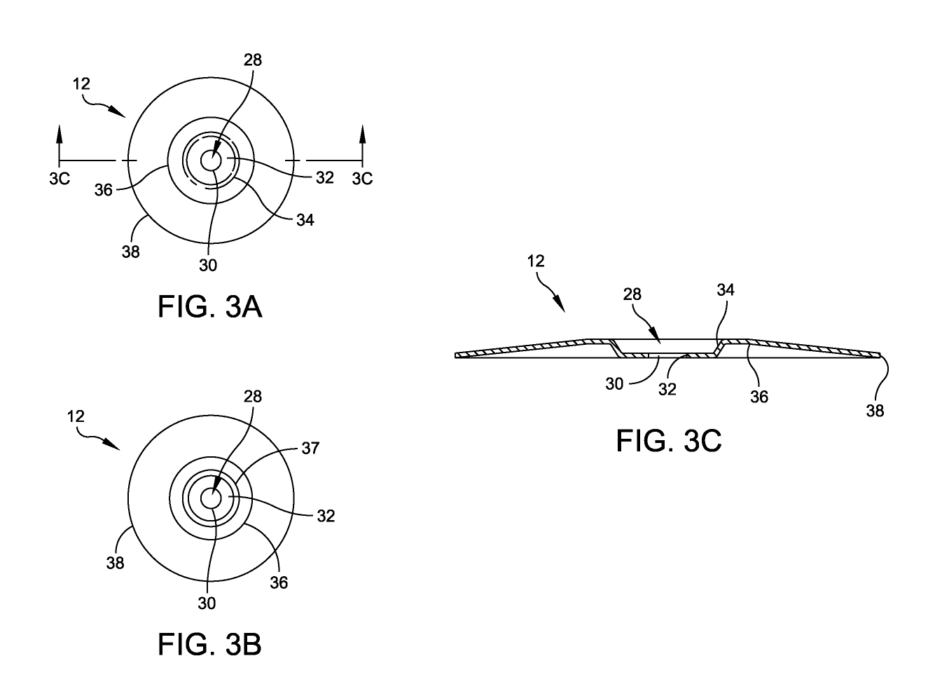

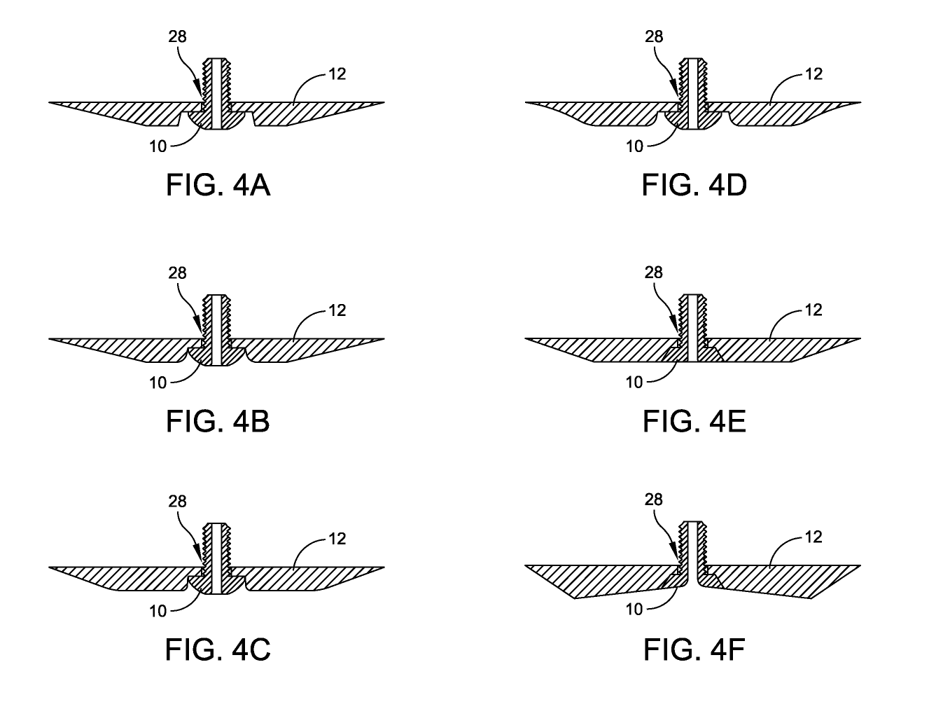

Referring to FIGS. 3A-3C, FIG. 3A is a perspective view of disbursement washer 12 of the present invention. Disbursement washer 12 has a plurality of varying diameters. Disbursement washer 12 has communication channel 28 extending through a center portion thereof. Disbursement washer 12 is preferably in a round shape, having an outer diameter 38 and an inner diameter 30. Inner diameter 30 defines the size of communication channel 28 travelling through disbursement washer 12. First inner diameter 32 extends in a radial fashion away from inner diameter 30. Second inner diameter 34 extends radially away from first inner diameter 32, wherein second inner diameter 34 may project upwardly from the plane of first inner diameter 32. Second inner diameter 34 may project in a convex manner so as to communicate with an abutting portion of body 21 of disbursement member 10. Third inner diameter 36 extends radially from second inner diameter 34 and preferably defines a surface that extends back in a downward, concave, fashion toward the plane of first inner diameter 32. The surface extending from third inner diameter 36 preferable extends to outer diameter 38, outer diameter 38 preferably being the same plane as first inner diameter 32. Upper surface 41 of the surface extending from inner diameter 30 to first inner diameter 32 is preferably sized and configured to be in direct contact with bottom surface 37 of disbursement member 10. It should be appreciated to one of ordinary skill in the art that there can be as many diameters within disbursement washer 12 as necessary. Each of the diameters may extend from the other in a convex or concave nature. It should also be appreciated that the angle of upper surface 41 extending from second diameter 34 to third diameter 36 may be any angle from 0 degrees to 180 degrees. Accordingly, third diameter 36 can be in fluid communication with sidewall 35 of disbursement member 35, wherein liquid flowing along upper surface 26 of disbursement member 10 can further be transferred to the surface extending from third diameter 36. The advantage of this particular embodiment allows the liquid to be transferred from fluid reservoir 18 into food container at a larger width of disbursement. Accordingly, this allows for adjustments to be made by the user of pot lid system 8, wherein for instance the adjoining surfaces of surface 26 and convex surface extending from diameter 34 to diameter 36 provide for a desired distribution of disbursed liquid being released from lid pot system 8. FIGS. 4A-4F depict illustrative examples of the connection points between disbursement washer 12 and disbursement member 10. FIG. 4A shows an example where liquid flowing in a downward fashion through communication chamber 28 will likely flow straight downward from communication chamber 28. Each of FIGS. 4A-4F depicts a varying degree of disbursement. FIG. 4F shows an embodiment wherein the liquid flowing downward from communication chamber 28 will likely travel along the tapered angle of disbursement member 10 and then along the surface of disbursement washer 12, providing for a wide range of distribution of liquid when compared to the embodiment of FIG. 4A.

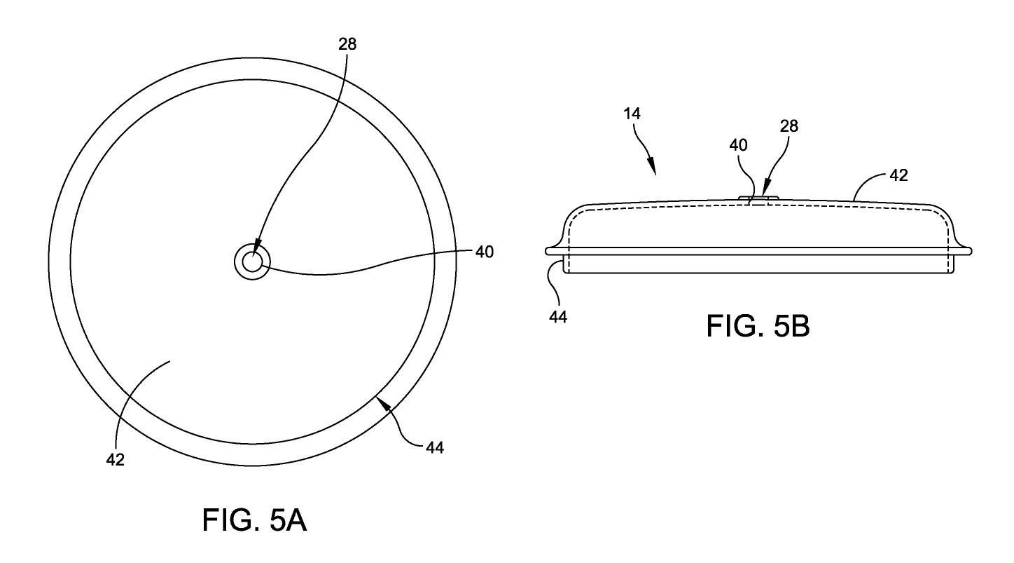

Referring to FIGS. 5A and 5B, FIG. 5A is a perspective view of lid body 14 of the present invention. Lid body 14 is configured to have communication channel 28 extending through a center portion thereof. Communication channel 28 is defined by an inner diameter 40 of lid body 14. Lid body 14 has an outer diameter 44 with a connecting surface 42.

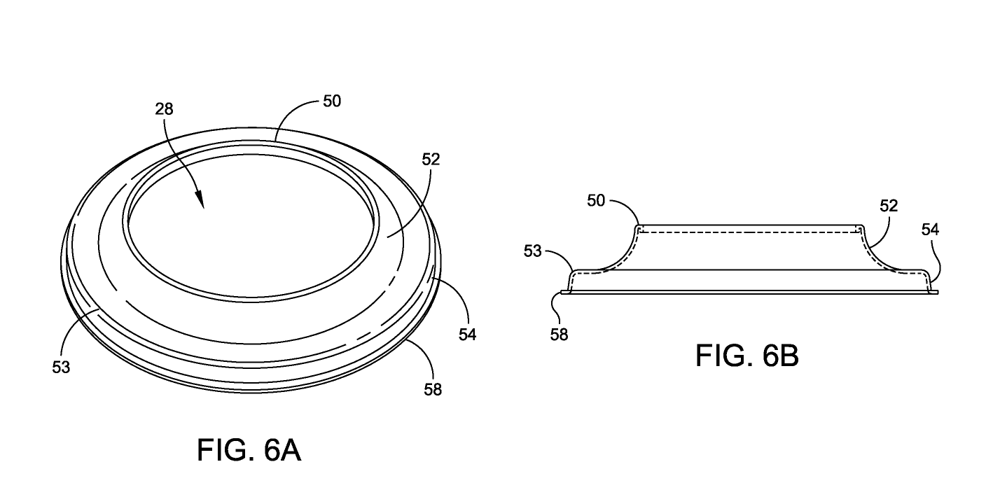

Referring to FIGS. 6A-6B, FIG. 6A is a perspective view of outer ring 16 of the present invention. Outer ring 16 has an inner diameter 50 and an outer diameter 58. Outer ring 16 is in the form of a circular ring sized and configured to abut its outer diameter 50 with surface 42 of lid body 14. Outer ring 16 may also have an mid-range diameter that separates the inner surfaces of 52 and 54. The walls 52 and 56 of outer ring 16 are thin and are in corresponding alignment with the outer surface, the width of outer ring 16 being as thin as possible to withstand varying pressures or being as thin as possible to allow for channel 28 to pass through outer ring 16.

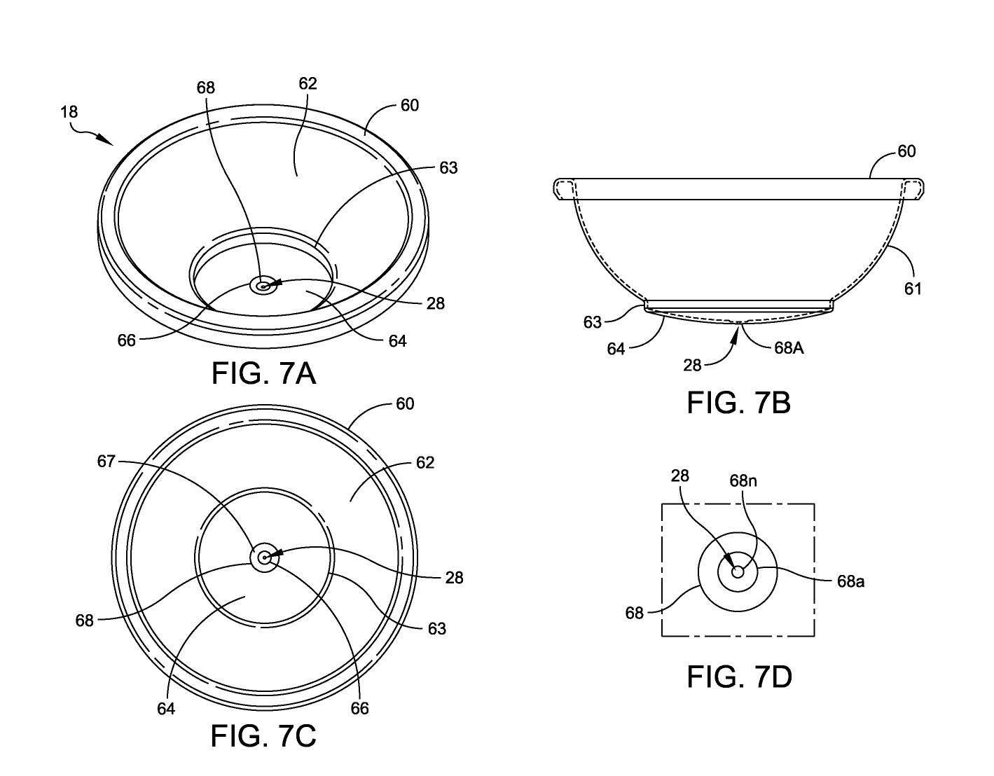

Referring to FIGS. 7A-7D, FIG. 7A is a perspective view of fluid reservoir 18 having communication chamber 28 extending therethrough of the present invention. Fluid reservoir 18 is a reservoir that contains liquid, such as wine, water, juices, sauces, etc., and allows the liquid, along with suspended solid-state particles associated with the corresponding liquid, to flow through communication channel 28 of pot lid 14 to thereby enter the food container. This allows for the liquid and corresponding solid-state particles to reach the food enclosed by pot lid 14, without having to remove pot lid 14 and thereby release the air particles of the inner container.

Referring to FIG. 7A, fluid reservoir 18 has an outer edge 60. Outer edge 60 may be rounded extending downward or it may come to a point facing upwards. Outer edge 60 preferably defines the outer most extent of fluid reservoir 18, outer edge 60 being circular, wherein the diameter of outer edge 60 may be as large or as small as desired by the user. There then exists a surface that extends toward first inner diameter 63, the surface having an inner surface 62 residing on the inside of fluid reservoir 18 and an outer surface 61 residing on the exterior of fluid reservoir 18. Surface 62 preferably extends inwardly at about a 45 degree angle from outer edge 60 to first inner diameter 63. It should be appreciated that surface 62 may extend at any angle desired by the user and it may extend downwardly and outwardly where first inner diameter 63 is larger than the diameter of outer edge 60. There then exists a second inner diameter 66, wherein surface 64 extends between first inner diameter 63 and second inner diameter 66. Surface 64 may be angled downward slightly at a 5 degree angle, at a substantially 0 degree angle, or perhaps at a larger angle. Surface 64 may act as the base of fluid reservoir 18, wherein if solid-state particles are going to accumulate on a surface, surface 64 would likely be the bottom surface with the largest surface area for the accumulation. There then further exists diameter 68 inside of diameter 66 wherein surface 67 lies in between diameter 68 and diameter 66. Surface 67 may be substantially angled, flat, or rounded downward in a radial fashion to thereby act similar to a funnel. Surface 67 allows fluid and associated solid-state particles to flow into communication channel 28. An embodiment of diameter 68 is further shown FIG. 7D. Diameter 68 may contain a plurality of inner diameters 68a, 68b, . . . 68n, wherein each inner diameter of 68a-n further acts as a funnel to the inner most diameter 68n. Inner most diameter 68n acts as the primary entrance point to communication channel 28. Inner most diameter 68n may be as large or as small as necessary. The larger the diameter of 68n, the liquid in fluid reservoir 18 will enter the food container at a higher rate and an increased amount of solid-state particles will enter communication channel 28. In the preferred embodiment, inner most diameter 68n has a diameter of approximately one (1) millimeter, with 0.35 millimeters often being adequate depending upon the alcohol content of the liquid in fluid reservoir 18. Inner most diameter 68n may be angled or provided with a straight cut through the surface of fluid reservoir 18. There may also be a plurality of inner most diameter 68n holes. There may also be a cap (not shown) to place on outer diameter 60. The cap may allow the user to leave pot lid system 8 unattended, without having to worry about an inadvertent spillover if someone bumps against the pot lid system 8 while fluid reservoir 18 is partially full and likely hot. It should be understood to one of ordinary skill in the art, based on the above described embodiments, that a plurality of different surfaces at varying angles can have desired effects for certain users. Therefore, the present invention is not limited to the embodiments described herein, and can be expanded to encompass surfaces of varying angles, rounded surfaces, etc.

In a different embodiment, fluid reservoir 18 may have a screen attached in a radial fashion along a plane of inner surface 62. The screen will be attached at a height above surface 64. The screen should not allow suspended solid-state particles of the liquid that has a large diameter than inner most diameter 68n to flow past the screen. This will allow the screen to stop solid-state particles that will not flow down communication channel 28 and prevent future clogging of inner most diameter 68n.

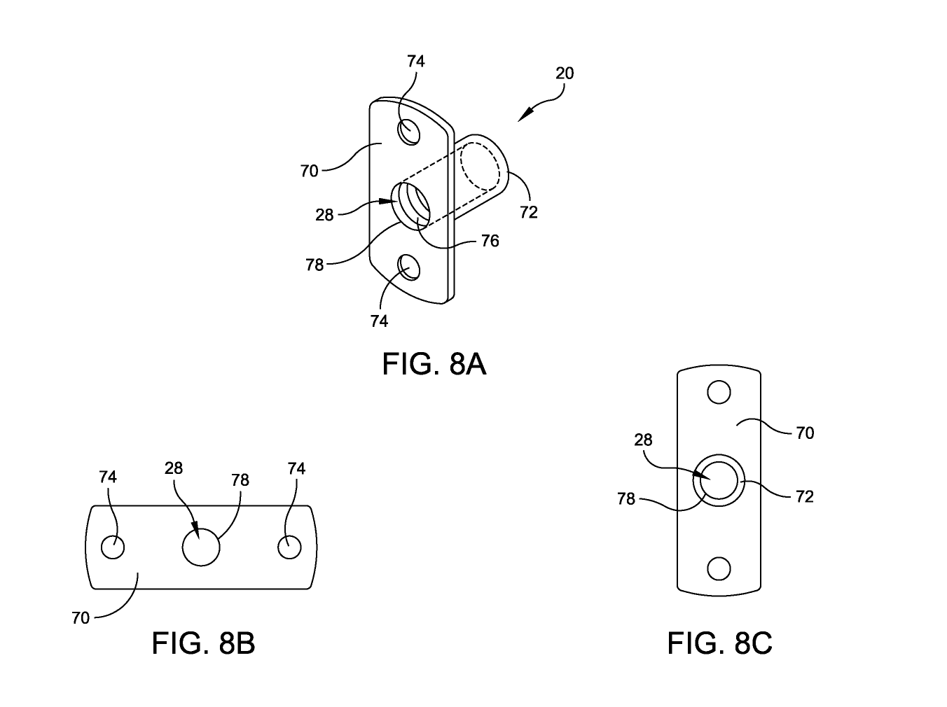

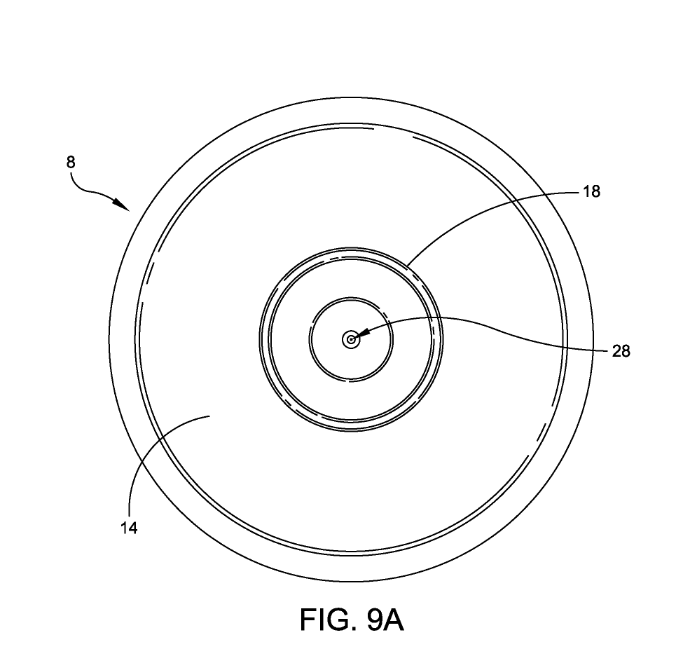

Referring to FIGS. 8A-8C, FIG. 8A is a perspective view of coupling device 20 of the present invention. Coupling device 20 has flange mechanism 70 and a hollow cylinder 72 projecting therefrom. Flange portion 70 may be in any shape or size. Flange mechanism 70 has an aperture 78 projecting through a center portion of it. Aperture 78 defines communication channel 28 that extends through coupling device 20. Flange mechanism 70 has a plurality of connection points 74, wherein connection points 74 connect flange mechanism 70 to a bottom surface of fluid reservoir 18, wherein aperture 78 is in fluid communication with inner most diameter 68n of fluid reservoir 18. Connection points 74 may connect coupling device 20 to the bottom surface of fluid reservoir through a variety of ways such as through welding or soldering. Hollow cylinder 72 projects from flange portion 70 wherein aperture 28 extends throughout the length of coupling device 20 such that communication channel 28 can extend through coupling device 20. Hollow cylinder 72 has width 72 with inner threaded portion 76 extending along the inner surface of hollow cylinder 72. The inner surface of hollow cylinder 72 is sized and configured to be secured with the threaded portion of disbursement member 20, and particularly with threads 32 of disbursement member 20. As disbursement member 20 interlocks with inner threaded portion 76 of coupling device 20, the disbursement member comes into direct contact with the lower surface of fluid reservoir 18 and forms in inner surface of communication 28 extending from fluid reservoir 18.

In an alternative embodiment, inner most diameter 68n of fluid reservoir 18 may not be the defining diameter with respect to the entrance of communication channel 28. In this alternative embodiment, inner most diameter 68n may be larger than aperture 78 of coupling device 20. In this case, aperture 78 may have a diameter of approximately one (1) millimeter, or a desired diameter, and be the smallest entrance into communication channel 28. In this embodiment, inner most diameter 68n of fluid reservoir 18 is larger than aperture 78 and acts as a funnel to direct the liquid with associated solid-state particles to communication channel 28.

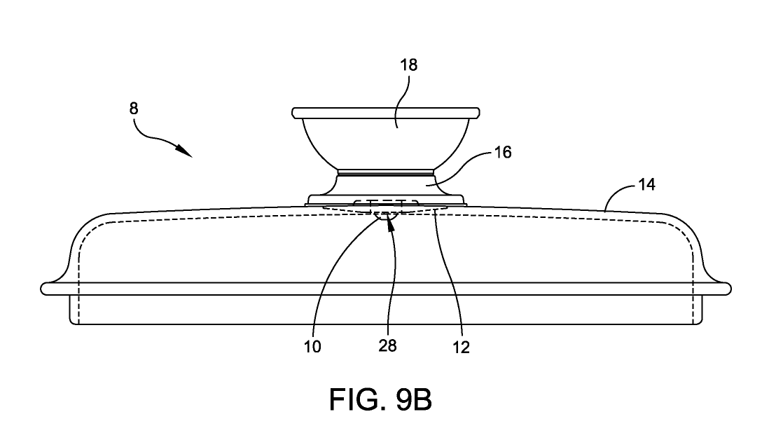

Referring to FIGS. 9A-9B, FIG. 9A is a perspective view of pot lid system 8 having fluid reservoir 18 that fluidly communicates an external environment with contents enclosed by lid body 14 of the present invention. As shown in FIG. 9B, fluid reservoir 18 having attached to a bottom portion thereof coupling device 20, fluid reservoir 18 projecting upwardly from lid body 14 and optionally abuts with open ring 16, wherein open ring 16 lies atop lid body 14 and beneath fluid reservoir 18. The attachment between fluid reservoir 18, coupling device 20, open ring 16, and lid body 14 allows for the alignment of inner most diameter 68n, aperture 78, the center of open ring 15, and inner diameter 40 of lid body 14. This alignment is critical in the formation of communication chamber 28. On the interior portion, or bottom surface of lid body 14, disbursement washer 12 abuts with a bottom surface of lid body 14, wherein inner diameter 30 of disbursement washer 12 is in direct alignment with inner diameter 40 of lid body 14. Furthermore, disbursement member 10 secures pot lid system 8 together. Hollow member 23 of disbursement member 10 extends into inner diameter 30 of disbursement washer 12 and then through inner diameter 40 of lid body 14. Threads 32 of the outer surface of hollow member 23 of disbursement member 10 interlock with the inner threaded portion 76 of the inner surface of hollow cylinder 72 of coupling device 20. As this male-female threaded attachment occurs, bottom surface 37 of disbursement member 10 abuts with the surface of disbursement washer 12 between diameter 30 and diameter 32. At this point, communication channel 28 extends from the inner most diameter 68n of fluid reservoir 18 through open ring 16, inner diameter 40 of lid body 14, disbursement washer 12 and disbursement member 10. Depending on the angle of surface 39, or lack thereof, on disbursement member 10, and the concavity and convexity match between disbursement member 10 and disbursement washer 12 (shown in FIGS. 4A-4F), the disbursement of the liquid and associated solid-state particles as it exits inner diameter 24 of disbursement member 10 will vary.

The components of the present invention can be composed of any suitable material. Pot lid 14 is preferably composed of glass. Disbursement member 28, disbursement washer 12, open ring 16, coupling device 20 and fluid reservoir 18 can all be composed of steel, metal, plastic, ceramic, or any like material capable of being constructed in a solid form and capable of withstanding heat for an extended period of time. An advantage of having fluid reservoir 18 composed of a material that conducts heat is that when cooking with wine, it is well known in the art that it is preferable to burn the alcohol out of the wine prior to cooking with it. During operation, if fluid reservoir 18 is a material that conducts heat, fluid reservoir 18 will heat up and thereafter burn the alcohol out of the wine, or alcohol in any liquid used, that is placed in fluid reservoir 18. However, some may desire fluid reservoir 18 to be insulated with an insulator that does not conduct heat well so that fluid reservoir 18 can be used to pick up pot lid system 18 when the cooking process is complete.

In using lid pot system 8, there are several methods to employ the system. For instance, first a user provides an open container and lid pot system 8. The user first engages outer edge 44 of lid 14 with the outer edges of the open container. At any time during the process heat may be applied or dissipated from the enclosed food container. The user begins to pour liquid with suspended solid-state particles into fluid reservoir 18. As this occurs, the liquid with suspended solid-state particles may optionally be filtered through a screen. If a screen is utilized, the screen employs slots that are at least as small as the diameter of inner most diameter 68n of fluid reservoir 18. The fluid then travels through communication channel 28 as it first flows through inner most diameter 68n. As the liquid flows through communication channel 28 it is released through disbursement member 10. The user has a few options on how the method of feeding liquid into the food container may be implemented. If the user desires a wide surface area distribution of the liquid flowing from communication channel 28, then the user will implement a disbursement washer 12 that has a surface in fluid communication with an upper surface 26 of the disbursement member 10. When this occurs, the liquid has a higher likelihood of being transferred to a wider surface area, than if a disbursement washer 12 is implemented that does not have a surface in direct contact with upper surface 26 of disbursement member 10. The method of feeding liquid into a food container therefore includes the changing of various disbursement washers 12. Finally, after the liquid with suspended solid-state particles travels through communication channel 28 and optionally gets transferred to disbursement washer 12, the liquid along with suspended solid-state particles is released into food container. The surface area of distribution can vary depending on the embodiment implemented by the user.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal thereof.

### ADVANTAGES OF THE INVENTION

Numerous advantages are obtained by employing the present invention.

More specifically, the flow of liquid and associated solid-state particles from a fluid reservoir gradually into a covered food container is provided that avoids all of the aforementioned problems associated with prior art devices.

In addition, a method of controlling the disbursement of liquid and associated solid-state particles from a fluid reservoir into a covered food container.

Furthermore an advantage is a system adaptable to control the desired disbursement of liquid flowing through the fluid reservoir into the food container.

It is to be understood that the present invention is by no means limited only to the particular constructions herein disclosed and shown in the drawings, but also comprises any modifications or equivalents within the scope of the claims.

What is claimed is:

1. A pot lid system, comprising:
a fluid reservoir having an open end and a substantially closed end, wherein said closed end has an aperture extending through a center portion of said closed end;
a disbursement washer having an opening extending through a center portion of said disbursement washer, wherein said opening of disbursement washer is in alignment with said aperture extending through a center portion of said fluid reservoir; and
a disbursement member having a channel extending through a center portion of said disbursement member, said disbursement member extending through said disbursement washer and connected to said fluid reservoir, wherein said channel is in fluid alignment with said aperture of fluid reservoir.

2. The pot lid system of claim 1, wherein said fluid reservoir further includes:
a coupling device having a flange portion, a cylindrical body portion and a coupling channel extending longitudinally therethrough in direct alignment with said aperture of fluid reservoir, wherein said flange portion is fixedly attached to said closed end of fluid reservoir and said cylindrical body portion extends from said flange portion in a direction away from said fluid reservoir.

3. The pot lid system of claim 1, wherein said fluid reservoir further includes:
an outer diameter forming an outer ridge;
a circular sidewall extending downward toward a center portion of said outer diameter;
a base extending from a lower portion of said circular sidewall in a substantially parallel plane to said outer ridge, wherein said base extends from the circular sidewall radially toward the center portion of said outer diameter and forms an opening in said base with an inner edge; and
a funnel having sidewalls extending from said inner edge of said base, wherein said sidewalls extend downwardly toward a center point and create an opening in said closed end of fluid reservoir.

4. The pot lid system of claim 3, further including:
a circular screen attached to said circular sidewall of fluid reservoir, wherein said screen filters out solid-state particles of a liquid that are larger than the diameter of said opening in funnel; and
a top releasably attached to said open end of said fluid reservoir.

5. The pot lid system of claim 1, wherein said fluid reservoir is composed of an inner layer and an outer layer, said inner layer being a metal and said outer layer being an insulator.

6. The pot lid system of claim 2, further includes:
a lid body having an opening extending through a center portion of said lid body,
wherein said cylindrical body portion of said coupling device extends through said lid body, and the inner surface of said cylindrical body portion having a threaded portion;
wherein said outer surface of disbursement member is threaded and releasably engaged with said inner surface of cylindrical body portion of said coupling device, thereby creating a communication chamber that extends from said aperture of fluid reservoir, through said coupling channel of coupling device, through said opening of disbursement washer and through said channel of disbursement member.

7. The pot lid system of claim 1, wherein said disbursement member further includes a body portion and a cylindrical hollow chamber having said channel extend through said body portion and said cylindrical hollow chamber, said body portion having an inner surface, an outer surface, a bottom surface, and an upper surface, wherein said upper surface extends away from said cylindrical hollow chamber at an angle from said inner surface and comes to a point where said upper surface comes into contact with said outer surface.

8. The pot lid system of claim 7, wherein said disbursement washer further includes:
a first diameter surface concentric with an outer diameter ridge of said disbursement washer, said first diameter surface abutting with said bottom surface of disbursement member;
a sidewall extending upward from said first diameter plane, said sidewall being in direct contact with said outer surface of disbursement member; and
a second diameter plane concentric with said outer diameter of disbursement washer attached to said sidewall and extending in a substantially similar plane as said upper surface of disbursement member,
wherein said upper surface of disbursement member and said second diameter plane are in communication such that water flowing from upper surface of said disbursement member will flow to said second diameter plane of disbursement washer.

9. The pot lid system of claim 1, wherein said disbursement member further includes a body portion and a cylindrical hollow chamber having said channel extend through said body portion and said cylindrical hollow chamber, said body portion having an inner surface, an outer surface, a bottom surface, and an upper surface, wherein said upper surface extends outwardly in a direction toward said cylindrical hollow chamber.

10. The pot lid system of claim 9, wherein said disbursement washer further includes:
a first diameter surface concentric with an outer diameter ridge of said disbursement washer, said first diameter surface abutting with said bottom surface of disbursement member;
a sidewall extending upward from said first diameter plane; and
a second diameter plane concentric with said outer diameter of disbursement washer attached to said sidewall and extending substantially parallel to said first diameter plane.

11. The pot lid system of claim 6, further includes:
a ring having a circular shape with an opening extending through a center portion of said ring, wherein the upper portion of said ring abuts with said closed end of said fluid reservoir and the lower portion of said ring abuts with said lid body.

12. The pot lid system of claim 3, wherein said opening in funnel has a diameter of one millimeter, said opening allowing liquid and suspended solid-state particles having a diameter equal to or less than 1 millimeter to flow through said opening of funnel.

13. The pot lid system of claim 1, wherein said channel of said disbursement member has a groove extending in a circular fashion through the sidewall of said channel.

14. A pot lid system, comprising:
a lid body having an upper surface and a lower surface with an opening extending through a center portion of said lid body, wherein said opening has a diameter;
a fluid reservoir abutting with an upper surface of said lid body and partially extending through said opening of lid body, said fluid reservoir having an open end and a substantially closed end, wherein said closed end has an aperture extending through a center portion of said closed end of fluid reservoir;
a disbursement member having a body portion and a cylindrical member extending from said body portion, wherein said disbursement member has a channel extending through a center portion of said body portion and said cylindrical member; and
a communication chamber extending from said aperture of closed end of said fluid reservoir, through said lid body, and through said channel extending through said disbursement member, wherein said communication chamber allows fluid to flow through it.

15. A method for feeding a liquid with suspended solid-state particles into a container, comprising:
providing an open container and a lid pot system, wherein said lid pot system includes a pot lid having a fluid reservoir with an opening through the bottom of said fluid reservoir, said fluid reservoir abutting with an upper portion of said pot lid, said lid pot system further including a first disbursement washer and a disbursement member, wherein said first disbursement washer and said disbursement member abut with a bottom side of said pot lid and said disbursement member engages with said fluid reservoir to create a communication channel extending through said pot lid system;
engaging an outer portion of said pot lid system with a top edge of said open container;
pouring said liquid with suspended solid-state particles into said fluid reservoir;
disbursing said liquid with suspended solid-state particles from said fluid reservoir into said closed container.

16. The method of claim 15, wherein said disbursement occurs directly below said communication channel.

17. The method of claim 15, further including:
removing said pot lid system from said engagement with said container;
replacing said first disbursement washer with a second disbursement washer, said second disbursement washer having a planar surface extending directly from said upper surface of said disbursement member,
disbursing said liquid with suspended solid-state particles from said fluid reservoir into said closed container, wherein said liquid with suspended solid-state particles travels on said upper surface of said disbursement member;
transferring said liquid from said upper surface of disbursement member to said second disbursement washer that is directly connected to said upper surface of disbursement member; and
releasing said liquid with suspended solid-state particles from said disbursement washer, wherein said liquid is disbursed to a wider surface area of said container than when released through first disbursement washer.

18. The method of claim 15, wherein said opening of said fluid reservoir has a diameter of 0.35 millimeters.

19. The method of claim 15, further including:
providing a screen attached to the sidewalls of said fluid reservoir, said screen having a plurality of slots that are at least as small in diameter than said opening in bottom of fluid reservoir; and
filtering said liquid with suspended solid-state particles after pouring said liquid in said fluid reservoir.

20. The method of claim 15, further including:
heating said container by applying a heat source to said container;
heating said fluid reservoir by applying heat to said container;
heating said liquid with suspended solid-state particles by heating said fluid reservoir; and
dissipating alcohol from said heated liquid with said solid-state particles in said heated fluid reservoir.
